(19) United States
(12) Patent Application Publication
(10) Pub. No.: US 2003/0059545 A1
(43) Pub. Date: Mar. 27, 2003

(54) Process for treating wood and products from treated wood

(76) Inventor: Darrell W. Kelsoe, Semmes, AL (US)

Correspondence Address: GREGORY M. FRIEDLANDER & ASSOCIATES, P.C., 11 SOUTH FLORIDA STREET, MOBILE, AL, 36606-1934, US

(21) Appl. No.: 09/788,165

(22) Filed: Feb. 15, 2001

Related U.S. Application Data
(60) Provisional application No. 60/086,001, filed on May 19, 1998.

(51) Int. Cl. B05D 3/02; B27K 1/00

(52) U.S. Cl. 427/393; 428/541

(57) ABSTRACT

The treatment of the wood with a reactive silicate which is preferably a carbon silicon halogen combination which replaces some of the molecules or atoms within the cellulose structure with silicon. Here, the hydroxyl (OH) group on some or all of one or more of the cellulose molecules is partially replaced with silicon or an alternative atom or molecule to changes the character of the wood. The process may be modified to insert a preliminary step of adding a reactive agent to be locked into the wood.

### PRIORITY

This patent is a continuation of Provisional Patent 60/086,001 filed Jun. 21, 2000.

### PRIOR ART

The prior art consists of various chemical and dry kiln loading and unloading for the wood. Silicon treatments are not unknown, but actual modification of the cellulose to incorporate a silicon shield.

Scientists and researches have been seeking an effective silicon based wood treatment for decades. Studies have suggested that silicon is effective in the treatment of wood. Difficulties have arisen, however, in how to effectively carry the silicon into the wood and keep it there. Studies performed by leading researchers in the United States and Europe have noted that the water repellent effects of silicon are often outweighed by the swelling of the wood. Tests comparing the effectiveness of wax resins and silicon have noted concretely that silicon based treatments provide statistically significant benefits.

In addition to the benefits of silicon are the well documented benefits of boron. Boron compounds are well known insect repellents and they are widely used in the treatment of wood products, primarily oriented strand board (OSB) and other manufactured wood products (especially, those that are used in residential construction). The biggest drawback of the use of boron in the treatment of wood is that it leeches out of the wood too quickly. This leeching has the obvious detrimental effect of leaving the treated wood in an un-treated state after a relatively short period of time.

Current wood treating techniques require that the wood be dried prior to the treatment process. This makes sense when viewed in relation to the previously discussed method of carrying the treatment to the wood with prior chemical treatments, if the wood is naturally “wet” (or green) the carrier is less efficiently absorbed and cannot effectively distribute the treatment chemical. Accordingly, wood is dried in one of several, expensive ways. Larger wood (i.e. railroad ties, utility poles, timbers, etc.) are typically “air dried”. This process requires that the wood be stored in vast lots where they will naturally dry due to their exposure to the elements. In addition to the costly management involved in the air drying process is the “hidden” cost of inventory. Most wood that is air dried is required to sit idle on a lot for 6-12 months. The financial burden of having to carry these enormous inventories of dormant wood has been estimated at nearly $100 million annually for the railroad industry alone.

The other common drying technique is kiln drying. This is a significantly faster process but the expense involved in the construction of the drying buildings and the energy utilized to force the wood dry can be just as expensive as air drying.

### GENERAL DISCUSSION OF THE INVENTION

The Wet Preservation Chemical Treatment, hereinafter “WPTC” is a chemical. “WPTC” or the Chemical has been specifically created for use in treating wood and wood products. The Chemical is preferably comprised of non-toxic and environmentally safe components where at least some of which react with molecules of wood. When the Chemical comes in contact with wood a reaction occurs which causes a molecular change in the wood itself improving the wood's strength and durability while simultaneously rendering the wood impervious to water, fire, rot, fungus, insets and many other environmental factors.

“WPTC” is a solution that contains, silicon and boron in the preferred embodiment. These two chemicals have been proven effective in the treatment of wood and wood products though there has been no ability to have the chemicals remain in the wood for extended periods of time or to control the release of one with the other. With “WPTC” at least one of these two chemicals are absorbed into and become part of the wood. Chemical equivalents may also be used.

Existing wood treatment methods require that a chemical be carried into the wood to create the desired results. The treatment methods most commonly used today utilize oil (in the case of creosote) or water (in the case of Chromated Copper Arsenate (CCA)) as the carrier to deliver chemical into the wood. These carriers are used to force chemicals inside of the wood to treat the wood and has no chemical action or reaction with the wood itself.

Several factors can result in differing levels of benefit to the treated wood using these current methods including:

The amount of the chemical in relation with its carrier (i.e. how diluted is the mixture);

The amount of pressure exerted on the chemicals to “force” it into the wood; and

The amount of time the wood remains under pressure.

These primary variables can be adjusted to produce different “grades” of treated wood for different end products. For example, a piece of dimensional lumber will not normally be as throughly treated as a pole that will be submerged under water. A railroad cross tie which will be in direct contact with the ground can be “treated” more than wood used in common decking. Typically, the higher the concentration of chemical to its carrier and the longer the treating time the higher the overall cost of treatment.

Water and oil carriers are lacking in that while they carry the chemical into the wood they also are carried into, and remain in, the wood itself. A standard cubic foot of untreated wood will absorb as much as 3.5 gallons of water or oil during a normal treatment process. Regardless of how much treating chemical is carried into the wood, the water or oil remain adding weight and no treating value.

The carrier for “WPTC” works with the molecule of the wood itself. “WPTC” is not carried into the wood but rather is drawn into the wood through a reaction with the molecules of the wood. The chemical reacts with the molecules of the wood to force an expulsion of the water and other liquids inside the wood and the creation, through the Chemical's molecular reaction, of a tough, highly resistant polymer shield. Because the wood draws “WPTC” into the wood itself there is no need to use high-pressure to treat the wood. This is a drastic departure from the more than century old process of utilizing high pressure to force various chemical and treating compounds into the wood.

Additionally, the treating of wood has always required that the wood be “dried” prior to treatment. Cut timber needs to be kiln or air dried to a level of approximately 14-20% moisture level prior to treatment with existing technologies. This process is costly in terms of time (air drying) or money (kiln drying) and adds a significant cost to the overall treated product. The drying process is necessary since the agent used to carry the treating chemical(s) into the wood need room to travel. A “green” piece of wood will not allow a prior art treatment carrier to enter to an acceptable level. It is somewhat akin to a wet sponge. When it is very wet it will not absorb any more moisture. It needs to be dried to a certain degree to allow more liquid to penetrate its surface.

Because “WPTC” is drawn into the wood through a molecular reaction, it actually works faster on a “green” piece of wood. This is due to the fact that the chemical reaction of “WPTC” is accelerated by the reaction or mixture with water and other natural liquids inside a piece of wood. This acceleration pulls the Chemical into the wood, causes a molecular reaction and may expulse the excess water and other liquids originally contained within the wood. It acts as combination treatment and drying process in one step. In the wet sponge example above, “WPTC” is drawn into the wet sponge and the original liquid is a carrier and may be replaced to some extent.

When the reaction with “WPTC” is complete water and other liquids are less able to enter the wood. With the molecular change in the wood's natural liquids and the creation of a protective polymer, the wood is naturally and permanently, protected from water; rot; insects; decay, etc.

Tests show that wood treated with “WPTC” in it's preferred embodiment is:

Waterproof

Decay Resistant

Insect Resistant

Stronger than before treatment

“WPTC” has been able to incorporate all of the benefits attributed to both silicon and boron and lock those benefits within the molecules of the wood. By using the natural liquids of the wood to literally “pull” the chemical into the wood while simultaneously reacting with these liquids, “WPTC” replaces the molecules of these liquids with the molecules of boron and silicon and ingeniously creates a polymer “shield” to encapsulate the solids thereby providing an unprecedented level of protection to the wood.

The result is a wood product that is nearly “petrified” in its defense against water, rot, insects and other ailments common to wood. Water literally “beads” on top of wood treated with “WPTC” due to this triple defense of silicon, boron and polymer shield. Rot becomes non-existent since it requires moisture to thrive. Since water is unable to penetrate into wood treated with “WPTC” rot is unable to take hold. Insects and fungus are cannot thrive by the lack of moisture, the presence of boron compounds as well as their inability to penetrate the polymer shield.

This same treatment works on aftermarket wood products (paper product and wood composites).

While current treatment processes require an additional chemical and treatment process to provide a minimal level of fire retardant, “WPTC” can be enhanced to create its own, natural fire retardant through the polymer and boron shield. This enhancement does not require any additional conventional equipment and can be completed as part of the chemical process.

In the United States alone over 110 billion board feet of wood is produced each year. This includes natural wood as well as man-made, manufactured wood (i.e. plywood, oriented strand board (OSB), manufactured timbers, etc.) It includes wood used for furniture, housing, industry, etc. The uses of wood are as vast as one can imagine.

The treatment of wood is performed by hundreds of companies throughout the country from small local firms to major, international organizations. These companies treat vast quantities of wood for commercial, industrial and residential use including railroad ties, utility poles, landscape timbers, dimensional lumber, fence posts, decking, etc. Wood has proven itself a highly capable resource and, due in large part to the increased production and manufacturing techniques in use today, is truly a renewable resource. Yet treated wood represents just a small fraction of the entire wood industry. Approximately 12 billion board feet of wood is treated in the U.S. today representing just over 10% of the entire U.S. wood market.

Existing treatment processes require that different wood products be treated at different levels depending on the specifications of the end use of the wood product. These different levels are primarily measured in pounds of solid chemicals per cubic foot of wood. In this manner a wood product used above ground will have less chemical carried into via the treatment process than one intended as a permanent wood foundation.

“WPTC” is environmentally friendly. On the environmental front, many within the industry recognize an obligation to protect the environment while simultaneously understanding that the economic advantages of a clean treatment can provide significant benefits in this ever increasingly regulated industry. In addition to the environmental component, the inability of the treating industry to penetrate more than 10% (+/−) of the wood industry due to the severe limitations of the current treating processes has created a desire to discover new methods of treating that will provide the benefits required of the balance of the industry.

“WPTC” is a chemical that has been designed to solve the decades old dilemma of environment over protection; to allow wood to be treated without altering the shape of the wood or causing any swelling. “WPTC” has been designed to be used on the nearly 90% of wood that goes untreated today. The ability to break into this market will not only create a huge market for “WPTC” itself, it will also revolutionize and forever change the wood treatment industry.

The chemical can also be used as an after-market treatment product. The after market product will be slightly different than the commercial product, typically in its level of strength. This is important since many existing structures and wood products can receive the benefits of “WPTC” even though they are already “in place”. Anticipated after-market examples include the treating of wood frame houses to eliminate termite and/or bug infestation; the treatment of previously installed (with or without treatment) railroad ties; utility poles; decking, etc. such that they receive the benefits of “WPTC”.

There is also a segment of the wood industry, that is part of the nearly 90 billion board feet that currently is not treated or is treated in an ineffective manner. The benefits of man-made wood are accelerating and the need for better, and more efficient wood keeps growing. Wood used in specific market segments such as the construction of mobile homes, wood decking in tractor trailers, wood flooring in railroad cars, shipbuilding and others, not to mention residential home-building, wood flooring in railroad cars, shipbuilding; and others, not to mention residential home-building; will all benefit significantly from a wood treatment that would render the wood waterproof; fired retardant; insect resistant and decay resistant.

Another use for “WPTC” is in the manufactured wood segment of the market. Manufactured wood is comprised primarily of Oriented Strand Board (OSB) and Particle board. The primary benefits to users of manufactured wood is that it is more economic to manufacture and is more adaptable to different uses since it can be shaped by machine. OSB can be formed in almost any shape. Manufactured wood is actually stronger than natural wood because of the way in which it is manufactured. Yet it is more economical because it uses small pieces (strands) of wood rather than relying on large, natural boards.

There are two significant drawbacks to manufactured wood, however. First is its level as a fire retardant. While acceptable for many uses it does not have a high enough level to be used in as many places as it could. Second is its unfortunate characteristic of swelling when it come in contact with water. Anyone who has seen a piece of particle board that has gotten wet can better appreciate this negative aspect of manufactured wood.

Using “WPTC” as a treatment for the raw material used in manufactured wood would solve these two problems. The level as a fire retardant would increase sufficiently to expand the market for these man-made woods even more so than they have to date. Even without such an expansion, existing markets have been clamoring for a higher level.

“WPTC” reacts molecularly with the natural components inside of wood (i.e. water; sugar; resin, etc.). The wood is warm to the touch just after treatment due to the chemical reaction. The end result is a dry piece of woods that has superior resistance to water, fire, rot, insects, etc.

“WPTC” works better on green, undried wood as there is more moisture for the chemical distribute and to react. When treating with “WPTC”, the costly and time consuming steps necessary in the drying of wood, whether through the natural, air dried process or forced, kiln dried procedure are unnecessary.

“WPTC” works on dried wood as it does on green wood. The term dried wood is a bit of a misnomer as there continues to be a level of natural liquids remaining in the wood. Wood that is dried, whether through natural aging or a kiln, typically retains about 12-18% of its original moisture content. The treatment process using “WPTC” requires a little more time and slightly higher pressure when performed on dried due to the lower level of liquid within the wood. The end, treated product is, however, just the same whether the wood was green or dried.

Current treatment processes use oil, water or other carriers to transport treating chemical into the wood. A significant portion of these carriers remain in the wood often causing swelling and/or warping of the wood. “WPTC” causes no such alterations.

Unlike current treatment processes, wood treated with “WPTC” does not gain significant weight. This is due to its unique nature of using the liquids within the wood as the agent to carry the chemical into the wood. Current treatments use oil, water or other carriers to transport chemicals into the wood. These carriers themselves remain in the wood adding as much as 25 pounds to every cubic foot of treated wood. Wood treated with “WPTC” has an almost even exchange (on a weight basis) with the weight of the natural liquids traded for the weight. This lack of weight gain is a critical cost advantage since transportation is one of the larger cost components of treating wood. Lighter wood means less cost.

Whether treated after the manufacturing process or by treating the wood components prior to manufacture, “WPTC” is an excellent treatment for these man-made wood products.

Unlike other treating chemical that require gloves and special protection, wood treated with “WPTC” is safe to handle after the treating process.

Care should always be taken when handling any chemical and such is the case with “WPTC”. The chemical itself reacts very strongly with liquids (i.e. that is how it evaporates the liquids within the wood). The chemical reaction may also produce a gas discharge that can cause harm if inhaled in a significant dose. One step in the process would be to neutralize the gas to environmentally safe compounds or modify the reagents used to effect this end.

Because wood treated with “WPTC” goes through a chemical change, the treatment alters the molecules of the wood to create a new molecule holding the sodium silicon and the boron compounds within a polymer shield. The level of leeching of the chemical may be controlled due to the fact that it is encapsulated within the wood itself to different degrees based on treatment techniques.

Though the molecular change that occurs in the treatment process changes some of the molecular components of the wood, it does not change the structural character of the wood detrimentally. It hardens the wood through the creation of the polymer shield. This polymer component acts like a kind of plastic. Depending on formulation it may increase or decrease the flexibility of the wood while strengthening the wood.

All wood can be treated with “WPTC”. Hardwoods, softwoods and man-made woods accept the treatment process. In current treating process there are different treatment levels, treating times and/or chemical dilution levels.

One variation for “WPTC” is the level of liquid within the wood being treated (i.e. “green” vs. “dried”). Less liquid in the wood requires slightly more time and pressure than wood with a higher level of liquid.

Because of the molecular change in the wood, the elimination of the wood's liquids and the creation of a polymer shield, wood treated with “WPTC” is especially well suited for in-ground and/or underwater use. Neither the salt nor the water can penetrate the wood to cause any damage.

Chemicals such as creosote are so dangerous as to have been banned in many states while in others it must be so diluted so as to severely inhibit its preservative properties. The trade off between environmentally acceptable chemical wood treatment and the preservative and protective properties of the wood treatment process has been fought for over 100 years.

“WPTC” has been designed to take advantage of the existing capital investment in place in the treatment industry in the form of equipment and other infrastructure and capital improvements. With minor modifications to existing plants and equipment, “WPTC” can be used by wood treating companies to produce environmentally safe, treated wood and wood products.

Because one carrier in “WPTC” is the water, sap and sugars in the wood itself, the treatment process works faster and better when the wood is still green. This is due to the chemical reaction created between “WPTC” and the natural components (water, sap, sugars, etc.) within the wood. The elimination of the drying process is significant for both its time and economic benefits.

Wood treating today follows a long and expensive path that ultimately produces a useable wood product. The path a standard 2″×4″×8″ pine stud would follow from forest to market in the treating process currently in use as compared to the process required with “WPTC” is shown below. It can be readily seen that the overall treatment process utilizing “WPTC” is significantly faster and more economical than current treating processes.

Current treating processes necessitate that the wood absorb a great deal of the chemical and the carrier (i.e. water or oil) which significantly increases the wight of the wood. A cubic foot of wood will hold nearly four gallons of water which can increase its weight by over 25 pounds. When wood is treated with “WPTC”, the liquids in the wood are actually removed. When compared to existing treating methods, “WPTC” results in significantly lighter finished products thereby drastically reducing transportation expenses.

Another benefit of “WPTC” is the handling of the treated wood. Wood treated with Creosote must be handled very carefully as the chemical is extremely toxic. Railroad workers, utility pole workers and other who handle creosote treated wood register constant complaints of swelling hands, sores and blisters from coming in contact with the chemical. “WPTC” is completely safe and can be handled without gloves or other protective equipment after it has been treated and poses no threat to users.

Still another benefit, though certainly not the last, pertains to the disposition of treated wood. Though claimed to be environmentally clean, wood treated with Creosote or CCA must be disposed according to very specific guidelines so as not to harm the environment. There are no such regulations for “WPTC”.

Current Treating Method

(a) A tree is felled and hauled to a sawmill;

(b) The tree is milled into rough wood pieces slightly larger than the finished product;

(c) The rough wood is kiln dried so as to remove up to 85% of the moisture content of the “green” wood;

(d) The rough, dried board is milled again to trim it to its finished size;

(e) The rough, dried board is treated by immersion into a highly pressurized (120 psi) cylinder filled with a mixture of water and a treatment chemical (“CCA”). The treating process typically lasts from 15-45 minutes;

(f) A 2″×4″×8″ pine stud contains approximately 4.5 board feet of wood. The stud will typically absorb about 1.3 gallons (approximately 10 pounds) of liquid (chemical and carrier) as a result of the treat process;

(g) The cylinder is drained of chemicals and a vacuum is created within the cylinder remove excess chemical from the wood and the boards are removed;

(h) The treated board is sent to be kiln-dried;

(i) The dried, treated, finished board is shipped.

“WPTC” Treating Method

(a) SAME

(b) SAME

(c) NOT REQUIRED

(d) The rough, “green” wood is milled again to trim it to its finished size.

(e) The board is treated by immersion into a slightly pressurized (15 psi) cylinder filled only with “WPTC”. The treating process requires 5-10 minutes;

(f) Due to the molecular reaction of “WPTC” and the wood's natural liquids, the wood expels liquid while absorbing sodium silicate and borax. The treated wood weighs approximately as much after treatment as before;

(g) The cylinder is drained of chemicals and the boards are removed;

(h) NOT REQUIRED

(i) Since no liquid was absorbed by the wood treated with “WPTC”, the treated stud weighs only as much as it did prior to treatment approximately twice as many studs can be loaded on a single truck cutting transportation costs in half.

Summary of Unique Properties of “WPTC”

WPTC reacts with the molecules and natural liquids of wood to draw in the chemical.

WPTC does not require high pressure, to force chemical into wood.

WPTC is able to treat green wood as well as dried wood.

WPTC treated wood is environmentally clean.

Since it becomes “part of” the wood itself the chemical does not leach out of the wood into the environment.

WPTC can be used (in a modified form) as an after-market treatment of existing wood.

Since no carrier is introduced into the wood WPTC does not cause swelling of the wood.

WPTC can be used in the treatment of OSB and other man-made wood products.

WPTC may introduce Borax and Sodium Silicate into the wood molecules thereby providing significant water, fire, rot and insect protection.

These and other objects and advantages of the invention will become better understood hereinafter from a consideration of the specification with reference to the accompanying drawings forming part thereof, and in which like numerals correspond to parts throughout the several views of the invention.

### BRIEF DESCRIPTION OF DRAWINGS

For a further understanding of the nature and objects of the present invention, reference should be made to the following detailed description taken in conjunction with the accompanying drawings in which like parts are given like reference numerals and wherein:

FIG. 1 is a view of the structure of cellulose of wood.

FIGS. 1a & 1b are alternative views of the structure shown in FIG. 1.

FIG. 2 is a view of a chemical process for altering the cellulose structure of wood showing one method of altering the structure of a single strand of cellulose.

FIG. 3 shows a generic representation of the formula shown in FIG. 2.

FIG. 4 shows one alternate structural cellulose target.

FIG. 5 shows an alternative target for the structure of treated wood.

FIG. 6 shows a genuine representation of cellulose.

FIG. 6a show one theoretical model for products by the process taught herein.

FIG. 6b shows what the inventor thinks is the more likely product generated by the process taught herein.

FIG. 7(a-c) show the most likely reaction with a silicon donor.

FIG. 8b1 and b2 show alternative intermediary boron molecules which may be utilized in the process.

FIG. 9 shows an alternative mechanism for achieving an alternative to intermediary 8b.

FIG. 10 shows the production of an intermediary (b) and a possible reaction using both boron and silicon (a) to guarantee a polymer with silicon and boron in the modified cellulose structure (c).

FIG. 11 shows a genuine representation of a reagent with cellulose (a). Here the reagent is generically listed as R—Si—(X)₃ where X is an O—R compound and R being an alkyl group; halogen, or a hydroxyl group (OH).

FIG. 12 shows a similar reaction to that shown in FIG. 11 with a boron molecule substituted for the silicon molecule. Alternative embodiment are shown as B1 and B2 where two hydroxyl groups on the cellulose which are replaced.

FIG. 13 shows a block diagram of a process to treat wood.

FIG. 14 shows a block diagram of a process to form particle board.

### DETAILED DESCRIPTION OF THE PREFERRED EMBODIMENT

The present invention relates to the treatment of wood more particularly the invention relates to the treatment of wood in such a way that the chemical structure of all or part of the cellulose is altered to preserve the wood.

Cellulose has an average degree of polymerization, dependent on the source, typically between 3,500 and 12,000 although a lower degree of polymerization is found in wood pulp which has been treated.

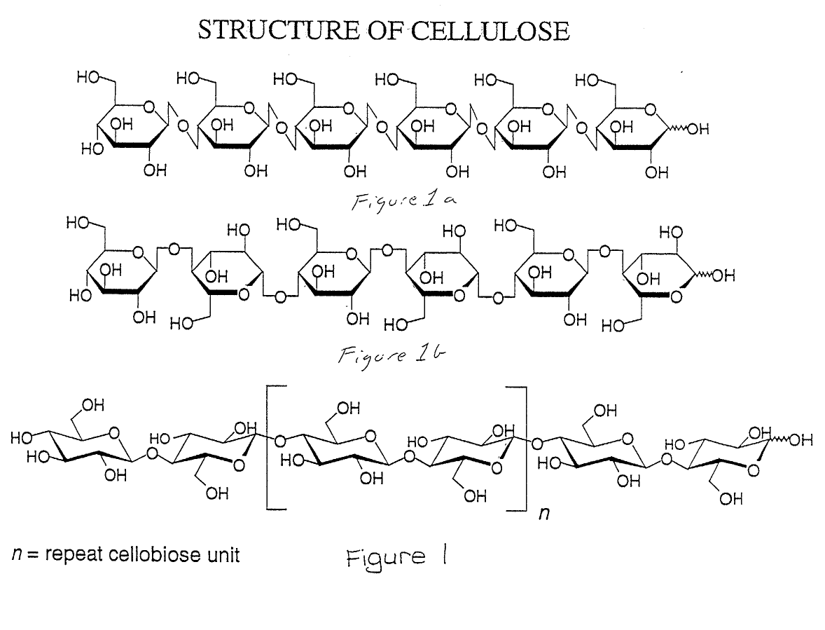

One of the primary ingredients in wood is cellulose which can be described as a chain of linked glucose units (FIG. 1). Cellulose is generally a six carbon and one oxygen chain as shown in FIG. 1. There are repeating units so that a consistent structure is indicated.

The primary way of dealing with wood treatment has historically been to cover the wood or insert some chemical in combination with the wood structure which would assist the wood by blocking the entry of elements or discourage insects from destroying the a basic cellulose structure.

What the present invention seeks to do is, rather than try to cover the wood from attack from elements or animals which might tend to damage the wood, to instead change the structure of the wood itself in order to protect the wood. The primary method disclosed herein would be to change cellulose and other chemicals within the wood so that all or part of these components are altered chemically.

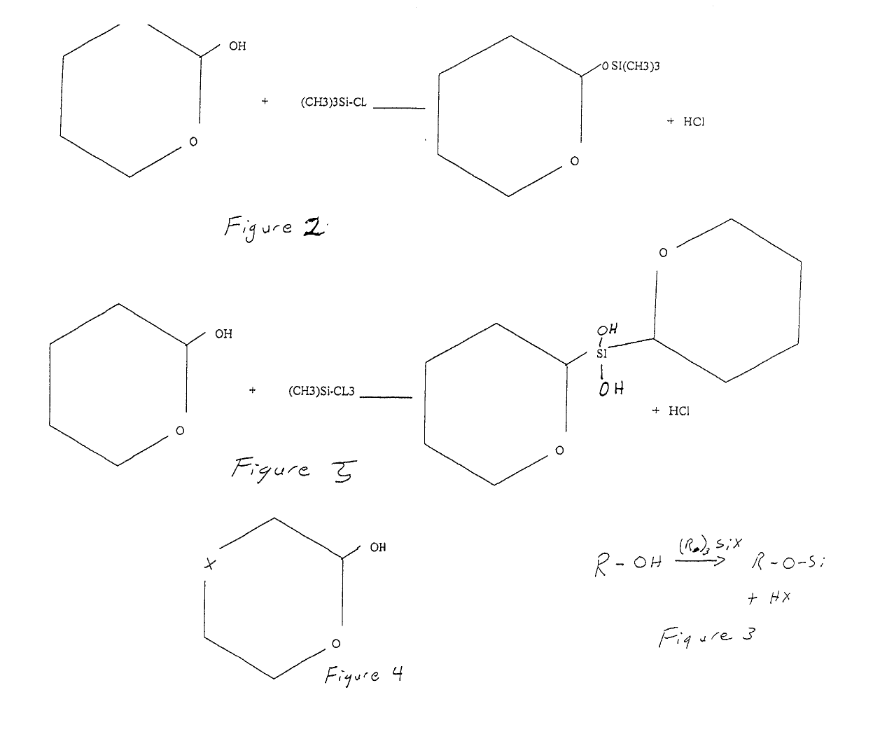

As shown in FIG. 2 one of the elements utilized in order to change the wood chemistry is silicon. In treating the wood in this manner, all of the wood or part of the wood may be so treated.

Historically certain treatments have been taught in the treatment of cellulose but only after it is extracted from raw wood and the present invention seeks to improve on that by describing a method and a specific product which can be utilized and created in order to change the structure in native wood and chip wood derivatives whether it be in a living tree or in timber or poles or wood composites.

Broadly the patent can be described as the treatment of the wood with a reactive silicate donor which is preferably a carbon silicon halogen combination which replaces some of the molecules or atoms within the cellulose structure with silicon. Here, as shown in FIG. 2 and 3, the hydroxyl (OH) group on some or all of one or more of the cellulose molecules is partially replaced with silicon. Many substitutions may be utilized in conjunction therewith, such as poly di methyl siloxane. A more complete list follows. Different diluents may be utilized and different chemicals may be added to change the degree of polymerization, the fire retardant features of the wood, to change the bug resistance, to change the water retention features and the like.

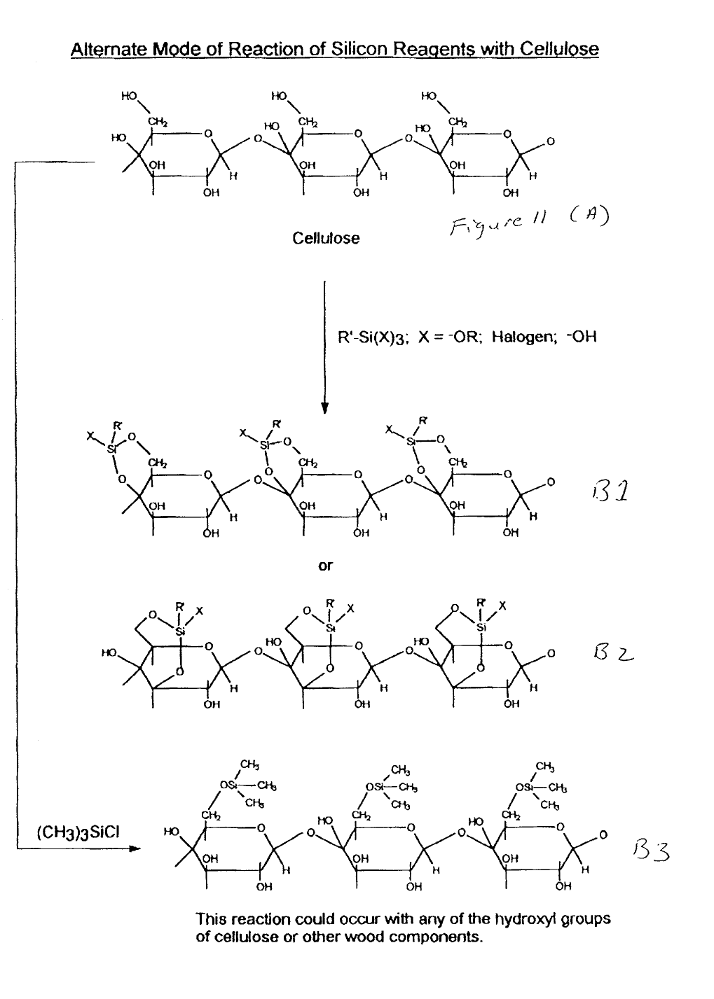

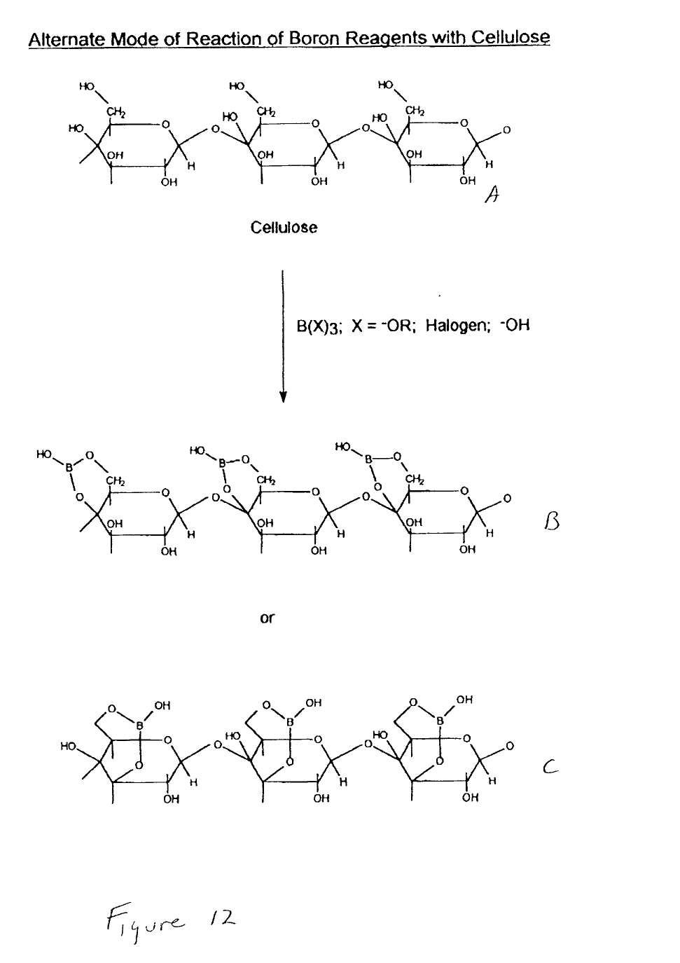

In the method shown in FIG. 10, the wood is exposed to a solution of tetrahydrofuran (90%) having 1 percent borax as an insect repellant and 9% methyltrichlorosilane MCl₃Si). As shown in FIG. 10, the MCl₃Si and boron has hydrolized to produce Msi(OH)₃ and B(OH)₃.

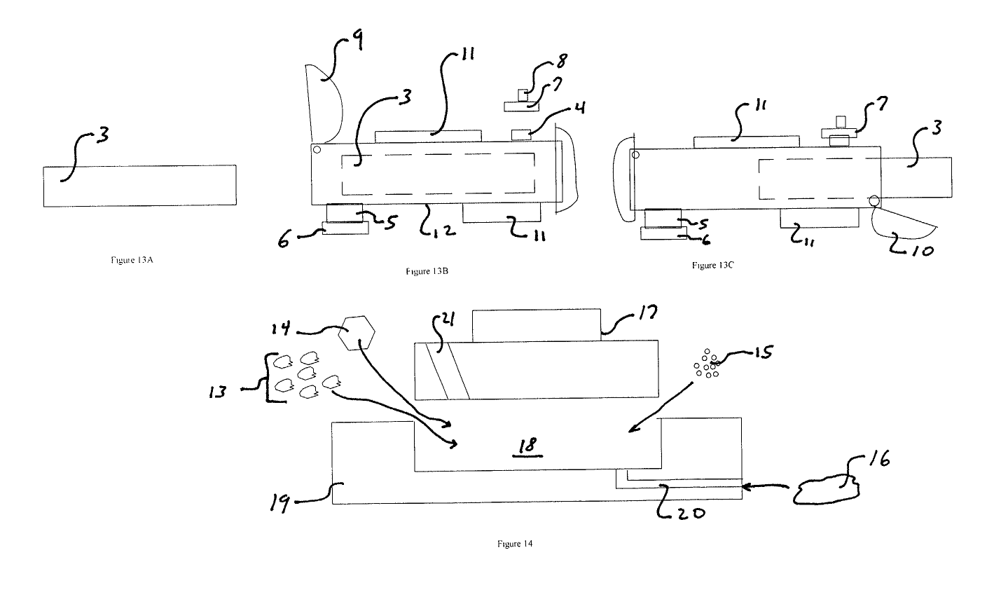

As shown in FIG. 13, this solution may be enclosed with the wood and heat from the reaction will add pressure which will increase the saturation. The release of pressure and heat will indicate a completed reaction.

Alternatively, the reaction time and pressure may be controlled so that less of the interior of the wood is affected to provide a surface treatment so that powdered boron or other substances will be less completely trapped within the wood product.

A modified process of spraying or brushing may be utilized. This would be useful on existing structures or living trees where immersion could be problematic.

The alternatives shown in FIGS. 4 and 5 show less likely and more difficult products possible where molecules (X or Si) are used to join cellulose molecules in a different way or to provide stronger bonding. Also, there is the possibility of making silicon or other replacements in the cellulose ring in order to further derivatize cellulose and other reactive components of the wood.

Specific embodiments taught herein use boron or other metallic or metalloid atoms such as boron, aluminum or a metal such as copper or compounds such as aluminum acetate containing those atoms that in conjunction with a carrier and preferably a reactive silicate of the type described herein in order to provide additional protection within artificially fossilized wooden products.

In the embodiment of FIG. 10 a metal carrier is utilized with methyl trichlorosilane to accomplish bonding between at least some of the cellulose molecules. When this chemical is applied to wood under appropriate conditions it substitutes for some or all of the hydroxyl groups. The reaction may be enhanced by water within the wood.

Borax is an example of a boron salt which may be used in conjunction with the process.

The steps (shown by structural method in FIG. 13) in processing the wood would be to prepare the solution, put the wood in solution and allow the combination of the wood and solution to be sealed so that the heat generated by the reaction between the methyl trichlorosilane the heat to build up pressure and when the pressure drops, thereby indicating that the heat generated by the reaction is ended or after a set period time if the wood is not to fully be treated. The wood is then taken out of the solution.

Alternatively the chemical compound described herein can be sprayed or brushed on the wood.

One alternative step in this process described in the present invention is to utilize this technology in order to treat composite wood which has glues which are favorably reactive with the silicon in order to strengthen the bonding within the glue. It is noted that certain solvents will not affect certain glues and a proper combination of glue and reactant mixture is necessary.

This can be found in what is commonly known as press board which utilizes a combining glue. In this way the wood, even in these compressed and glued products, is treatable. The silicon may participate to strengthen the bonds in the glue where a proper combination is utilized.

Similar derivatization can be accomplished with other components of wood such as lignin, carbohydrates and polysaccharides in order to accomplish similar results.

Other techniques disclosed in the present invention incorporates the use of ultrasound in order to increase the ability of the wood to carry the reactive/fossilization compound of the type described herein or a traditional treatment mechanism (FIG. 13).

In order to incorporate Boron, Borax or Boron Anhydride may be used. In addition Boric Acid or trimethyl borate, a boron halide such as boron and fluorine or boron and chlorine in a salt can be used for different effects.

THF (Tetrahydrofuron) or acetone are exemplary solvents.

Silicon donors include methyltrichlorosilane, triethoxyoctysilane, octeotrimethylsilane, clorotrimethylsilane and phenyl trichlorosilane.

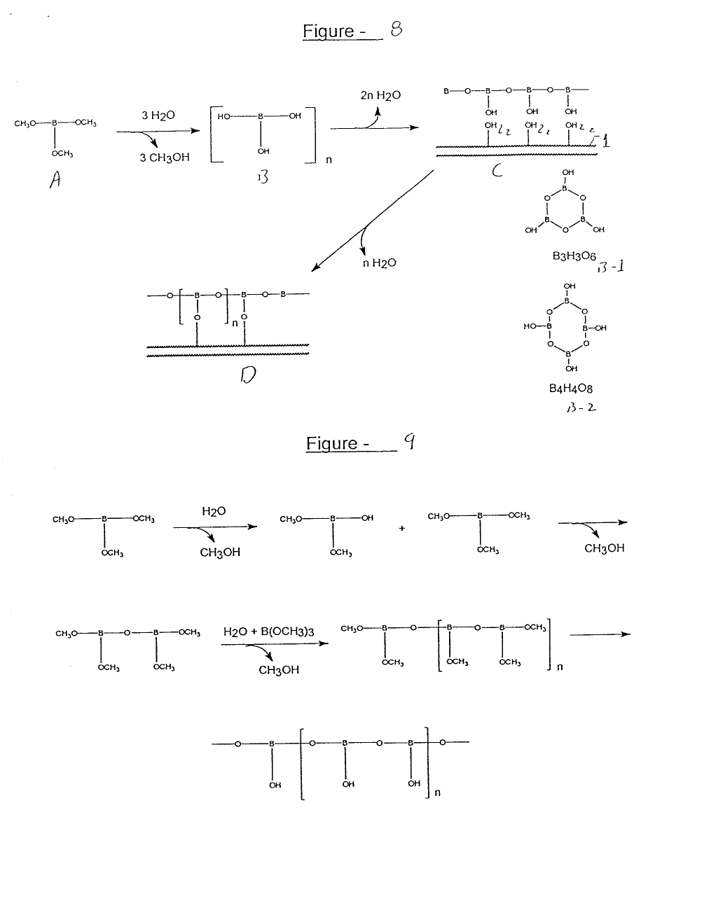

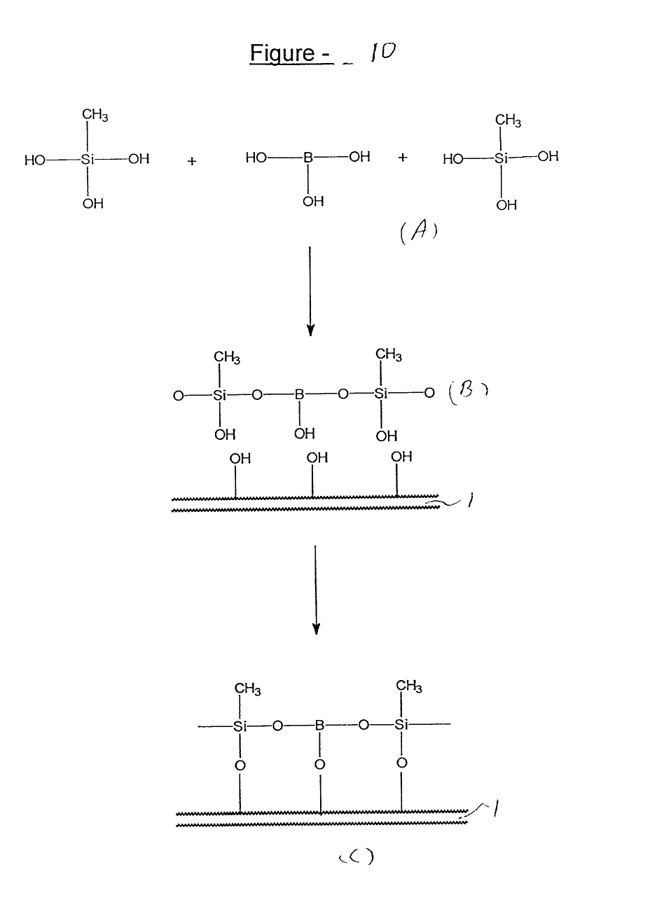

The basic chemical process includes taking the silicon and/or boron donors (or their equivalents) with three water molecules from water and in the case of boron that would yield boric acid plus water plus H2B4O7 in the case of trimethyl borate or a different carbon borate. (FIGS. 7 and 8)

These would each react with one of the OH or hydroxyl groups of the cellulose.

The silicon would bond at the same location as the hydroxyl group. If boron and silicon are used together, a certain proportion of the hydroxyl groups would be replaced with the boron compound and a certain number will bond with a silicon compound and in some cases there could be an exchange.

The basic structure of the molecules used in the process described herein include:

R-Xa-Xb3

or

R3-Xa-Xb

R is a carbon compound, Xa is a trivalent, tetravalent or penta valent atom and Xb is a reactive seven valence halogens (florine, chlorine, bromine, etc.) or their equivalent.

Hence, silicon donors might be shown with the general formula R—Si(X3) This silicon donor can be represented by the general formula where X is a halogen such as chlorine, bromine, iodine, or an alkoxy group (such as methoxy, ethoxy, propoxy, butoxy or an alkoxy group with the number of carbon ranging from 3 to 20 in a straight chain or a branched chain configuration (larger chains presumably causing interference problems with the reactions). The X may also be a phenoxy group, a benzyloxy group or an aryloxy group in which the aromatic ring is replaced with a polycyclic aromatic ring.

Silicon could be replace with Ge, Tin or lead subject to environmental concerns and the qualities desired. For example, land may be useful in the construction of nuclear plants.

The amount of the mixture of the boron and silicon donors with the solvent will determine the type and extent of bonding.

While boron and silicon are used to this example, titanium would work and so would many trivalent, tetravalent, or pentavalent atoms. In other words 3, 4 or 5 valence state atoms [and potentially molecules] would work in the bonding process. Examples of substitutes for boron include Aluminum, Galium, Indium or thalium (Tl), by way of example.

Reagents: Boron and Silicon and Related Reagents Include:

a) Boron oxide (B2O3) [other metals having a 3, 4 or 5 valence outer shell could also function in this manner.]. This chemical reacts with moisture and water within the wood or wood products to generate Boric Acid that could be entrapped within the silicon shield (when used as a mixture with silicon donors]. Different methods may be pursued within the art using:

b) Chlorotrimethylsilane

c) phenyltrimethoxysilane

d) Triphenylsilylchloride

e) Propyltrichlorosilane

f) Propyltriethoxysilane

g) Hexamethyldisilanzane

h) Titanium tetrabutoxide [TBT]-an example of a tetravalent metal in place of silicon.

i) Triethylorthosilicate

j) OCTEO-S [n-octyltriethoxysilane, TECH];

k) Octyltriethoxysilane

l) trimethylborate [TMB]. This reagent reacts with water/mixture within wood to undergo partial or full hydrolysis to polyborates or boric acid respectively. (See FIGS. 8, 9 and 10). It could react after partial hydrolysis with methyltrihydroxysilane to form mixed boron and silicon polymers as shown.

m) Tri-ethylborate is a reactive alternative which shows the use of an ethyl group in place of a methyl group to produce a similar result with a larger carbon chain. Large carbon chains or ring compounds may also be used as long as the carbon groups are not so large as to interfere with the reaction.

n) Boron halides generally are workable, such as borontrichloride, borontribromide and borontrifluoride. These are highly reactive compounds which directly react with the hydroxyl groups of wood cellulose or other compounds of wood to form respective borates with the elimination of acid halides.

o) Boric acid: A 0.5 percent solution in acetone with an appropriate amount of TMB can be used for a more stable formulation with a silicon donor such as MTS (Methyltrichlorosilane).

p) Methyltrichlorosilane [MTS]: This reagent in THF as a carrier is one of the initial formulations. FIG. 7 shows the hydrolysis of MTS to methyltrihydroxysilane within the wood (postulated) and it's subsequent conversion to a polysiloxane that reacts with the hydroxyl groups of wood cellulose forming the polymer shield.

FIG. 4 shows one alternative end product where one of the cellulose carbons is generally replaced with an atom, such as boron identified as X.

FIG. 5 shows a second alternative end product where the oxygen connecting cellulose is replaced with silicon (or some other atom or molecule. While neither the embodiments shown in FIGS. 4 and 5 are considered likely products or intermediaries.

If, in a reaction hydrochloric acid is released it would preferably be diluted, degraded (neutralized), or otherwise removed during or after the treatment process to prevent the degradation of the wood or irritation caused by the slow release of this acid to the environment. It could, for example, be converted to environmentally safe and natural salts.

This reaction might be shown as:

R—Si—X (here (CH3)—Si—Cl₃) in a solvent to yield—R—Si—(OH)₃ (Step A) which would subsequently react with cellulose (Step B) to form the modified cellulose chain (Step C) plus water.

Diatimatious earth, sodium silicates, or other boron or silicon salts may be used as a source of donor atoms. These may be mixed to provide intermediaries in solution which would, working together, carry out the desired end product in the wood. Examples of products having these qualities include boric acid, trimethy (trialkyl) borate, Boron Halides (BF3, BCl3, etc.), and Boric Anhydride (boron oxide).

Anything that bonds to the molecule could potentially remain to it in this case carbon groups via and oxygen are shown but other molecule alky aryol or poly cycle compounds could be used.

SOLVENT: The solvent can vary tremendously also although it is preferably a non water based solvent so as not to cause a reaction or minimal water compound so it is not going to cause a reaction prior to the addition to the wood and also it would typically be structured so as not to effect the glue or other properties of wood composites.

(Acetone) is also a good carrier for non-glue wood composites.

(THF (Tetrahydrofuran)) works well with glues used in wood.

Poly dimethylsiloxane. May be used as an additive to boron compounds to result in the silicon and boron compounds.

Water is also a solvent used in some cases. Water may be used with this formulation as an alternative to part of the organic solvents in certain formulations.

Although the various silicon-boron combinations with or without the additives will work on all wood and treated wood and wood products with varying efficiencies and compatibilities individual varieties in results may occur with the nature of the solvents used to prepare the formula with the kind of sample of the wood to be treated. For example the acetone based formula may be optimal for soft wood, whereas the acetonitrile based formula for hard wood. Likewise the non-acetone based formula may be the preferred embodiment for treatment of Particle Board, OSB or Chip Board where the glue is dissolved by acetone, while the acetone based formula may be better for southern pine and the like.

In some cases the solvent and additive may react in order to form a gel and in some cases it might be useful to agitate the solution in order to prevent that from happening.

The proportion of chemicals results in different finishes and features and the solvents can also contribute to the variety of product out-comes.

Other solvents includes any water compatible organic solvents such as dioxain. One of the key elements of the solvents would be that it would have a boiling point under a 100 degrees Centrigrade.

It is believed, but uncertain that borax and sodium silicate are trapped inside a polymer shield when we do not use methyltrichlorosilane.

The modified “WPTC” formula comprising of borax, sodium silicate and MTS appears to have the theoretical basis for polymer shield and the conceived entrapment, but these need to be scientifically established before filing the formal application.

The current “WPTC” formula incorporating the carbon-silicon-halogen reagent, a boron donor, borax, sodium silicate, metal or metalloid catalysts or enhancers with THF or it's equivalents as the solvent.

The logical next step for “WPTC” is the expansion of specific carrier solvents, stabilizers and enhancers. An example of a chemical additive as an enhancer to retard fires are phosphorous compounds.

The purpose of the invention is generally to accelerate an alternative to fossilization of wood by providing an environment conducive to this. This works to crystalize or plastisize the wood. Copper compounds may be used in place of or in conjunction with silicon and boron within the process embodied herein.

Enhancing Processes

One method of enhancing the process is to provide that it be done in an enclosure (to allow the chemical reaction to build pressure), under pressure induced from external factors to the chemical reaction and the use of ultrasound to speed up the process by aligning the molecules within the wood (whether cellulose, lignens or other molecules alone or in groups).

Other pre-treatment steps include the infusion of moisture in the wood before or during treatment. Also the use of wood closer to the production stage (i.e. greener wood) or putting other solvents to water within the wood prior to treatment with the chemicals in order to provide carrier chemicals within the wood. Water might be mixed with wood composites in order to help the process along.

Also donors (of boron or silicon for example) may be infused within the wood prior to the addition of the solvent. This would be particularly simplified where wood composites (fiberboard for example) were being manufactured prior to being treated in the process steps.

The R group in the above silicon donor is an alkyl group ranging in a carbon chain length of 1-20 units in a straight chain or branched chain configuration. All these reagents are capable of undergoing the similar transformation as depicted in FIG. 7. While halogen substituted reagents are very reactive and the reaction could be completed within a few hours, the non-halogen substituted silicon reagents with this general formula react only slowly and the completion of the reaction would require a few days under ordinary conditions. However this process could be enhanced by the inclusion of acid or base catalysts to the silicon reagents. These catalysts may include but not limited to a metal alkoxide or an acid such as meta-phosphoric acid.

1) Other hydrophobic Reagents: In the above general formula Silicon (Si) can be substituted with Titanium (Ti) and all other factors may remain the same. A typical example would be Tetramethyltitanate. A general representation of the formula would be Ti[R]₄ where R=a halogen, an alkoxy group, a phenoxy group or a benzyloxy group as defined above for the silicon donor.

### Other Wood Cellulose Modifying Reagents

1) The following silicon reagents can also react with the hydroxyl groups of wood components to render wood hydrophobic and insect and fire resistant. They are:

Dichlorodimethylsilane represented by the general formula: [R]₂ Si (X)₂; where R=an alkyl group ranging in carbon chain length of 1-20 units as a straight chain or as a branched chain, or a phenyl group or a benzyl group and X=a halogen, an alkoxy, aryloxy or benzyloxy as defined above #(2). Another common example is dichlorodiphenyl-silane.

Chlorotrimethylsilane represented by the general formula [R]₃ Si—X, where R=is the same selected from the above and X=is the same selected from the above. Another common example is Chlorotriphenylsilane.

Hexamethydisilazane: This compound will form a trimethylsilyl derivative of the hydroxyl groups of the components of wood or wood products with the evolution of nitrogen in combination with an appropriate catalyst. The catalyst may be phosphoric acid that by itself may render the wood fire resistant.

Octyltriethoxysilane [OTS]. This is an excellent reagent that would function in Neutral environment. The drawback is high boiling point [difficulty drying] and slow reaction (more than a week after treatment). A significant waiting period may be required to complete the process. The reagent is cost-effective [$3.00/Lb] and environmentally clean. Possible improvements to speed up the reaction with the addition of catalysts [metaphoshoric acid] that could also render fire proofing remains attractive. Another common example is Propyltriethoxysilane.

### Phosphorous Reagents

Phosphorous reagents can also be used to derivatize (modify) the hydroxyl groups of wood components to make the wood fire and insect resistant. Common reagents that can be used for this purpose are:

Triethylphosphate: Here phosphorous is in the pentavalent state and the trimethoxy groups are prone to hydrolysis by moisture/water within the wood and generate phosphoric acid or polyphosphoric acid which is a fire retardant. The hydroxyl groups of the cellulose or other wood components may directly react with Triethylphosphate displacing one or more of the methoxy groups with the formation of a chemical bond between the phosphorous and the oxygen atoms of one or more of the hydroxyl groups. Another common example is Trimethylphosphate.

Triethylphosphite: Here phosphorous is in the trivalent state as in trimethylborate [TMB] and the mechanism of reaction with wood or wood components are identical to those of TMB as described above. As is the case with TMB there are two possibilities. Triethylphosphite can react with moisture/water in the wood or wood components to produce phosphorous acid or polyphosphorous acid within the wood to make it fire and insect resistant which when used in combination with a silicon reagent would render the phosphorous acid trapped inside. Alternately triethylphosphite can react with one or more hydroxyl groups of wood cellulose or other components of wood to form permanent chemical bonds to render wood fire and insect resistant. Another common reagents are Trimethylphosphite or Triphenylphosphite.

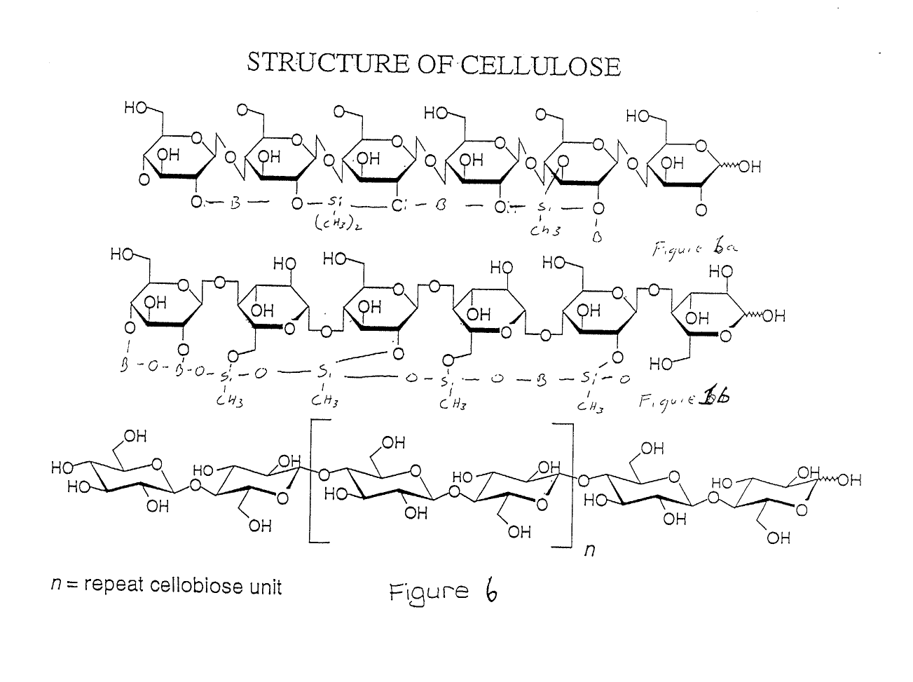

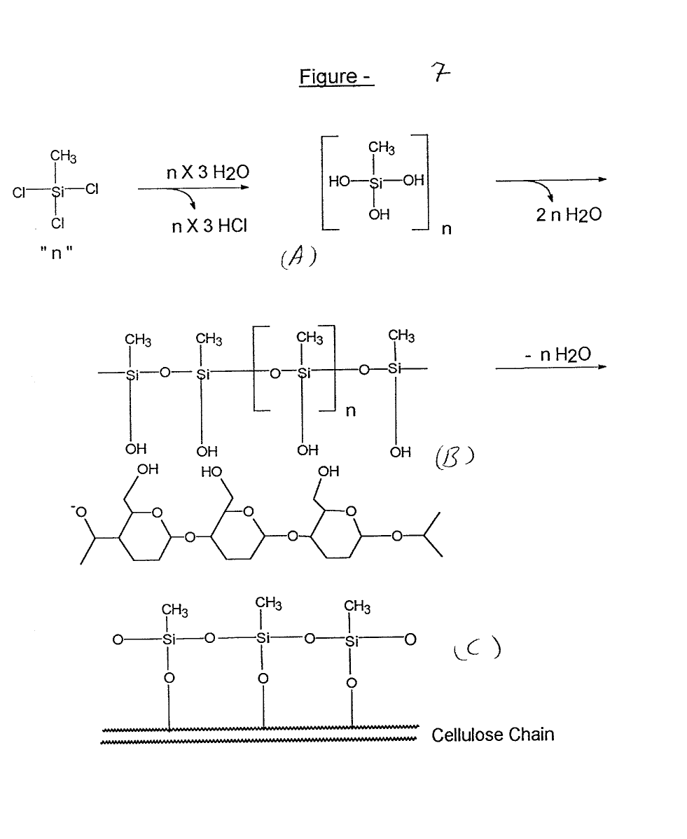

While no chemical process necessarily results in a single outcome. FIG. 6-b shows an approximation of the most likely end structure for cellulose without a complete replacement of hydroxyl atoms in the chain when treated with a mixture of silicon and boron under the process steps taught hereunder.

FIG. 6a shows a less likely structural outcome which is improbable and is given more for purposes of disclosing all manner of potentially allowable structures as opposed to the structure considered a likely end product.

FIG. 8 shows the reaction postulated for a boron donor. The corrugated double line 1 represents the cellulose polymer while the cellulose OH groups are non-remarkable, hydroxyl groups coming off from individual cellulose molecules within the polymer as a result of the reaction.

This shows where B(O CH₃)₃ (A) is converted to an intermediary B (OH)₃ (B) which then reacts with the hydroxyl groups (C) to yield a polymer of Boron and Cellulose polymer.

FIGS. 8B1 and B2 show alternative intermediary boron molecules which may be utilized in this process.

As can be seen by reference to FIG. 13, the process of treating wood may be described as introducing a wood product 3 to a chamber 12 which opens at entry 9. The entry 9 is then closed and if desired an electromagnet field is introduced to contract the reaction using field generators 11 which may be magnets or ultrasound to obtain desired alignment to enhance or restrict the reaction.

In the preferred embodiment ultrasound is used to align and open the partial passages of the wood to enhance penetration.

This field may be maintained by the process or it may be begin and begin and stopped repeatedly or terminated after a certain time to get the desired penetration or to limit the treatment area to the surface of the wood by closing the natural wood passages.

At this time or before one or more reactants may be introduced into the chamber 12. Thereafter the entry 9 is closed. The reactants or removing reactants are introduced through a chemical opening 4 in the container which may be sealed by a valve 7. The valve (or otherwise) may include a temperature or pressure monitor to determine when the reaction is complete or when it has reached a certain level. The chamber may be vented.

At any point the reagents may be drained through a valve in a drain 5 and other chemicals, such as acid neutralizing agent added to wash or treat the partially treated wood.

Thereafter the wood my be removed from the entry 9 or an appropriate exit 10 so that one piece of wood may be used to push the other out in an automated process.

FIG. 14 show how particles of wood 13 may be turned into particle board utilizing the process through the steps of combining the particles 13 with a glue 14 and one of the reagents (such as borax) in a chamber 18 in the bottom 19 of a press. Before, after and during the compression process when the top 17 of the pump presses on the mixture of glue, wood and reagent, a solvent 16 may be introduced through a passage 70 in the chamber to initiate the reaction a pressure release valve 21 may be used to allow gases and pressure to escape this process.

The process of locking in beneficial atoms or molecules within the wood structure comprising the steps of:

(1) Selecting an additive which may enhance a desired property from the group of properties comprising:

(a) Fire resistant,

(b) Insect resistant,

(c) Moisture resistant,

(d) Modified by color or stain,

(e) having better glue attachment qualities,

(f) having better insulation qualities, and

(g) to change the chemical structure of cellulose or some other chemical within the wood to change specific characteristics to the wood.

(2) Adding the additive to the wood:

(a) mixing particles of wood with the additives and forming a wood composite;

(b) dissolving the additive and flowing the additive into the wood or;

(c) pressing the additive with the wood in a gas or solid phase;

(d) reformulating the wood cellulose polymer to create a partial or full barrier to leaching.

An added step would be to enhance absorption of the additive or reformulating chemicals using (i) alignment and/or opening of wood pores using ultrasound, electromagnetic fields, heat, heat with steam and the like.

Because many varying and different embodiments may be made within the scope of the inventive concept herein taught and because many modifications may be made in the embodiment(s) herein detailed in accordance with the descriptive requirements of the law, it is to be understood that the details herein are to be interpreted as illustrative and not in a limiting sense.

1) A method for treatment of wood having an exterior layer and interior layer and a surface comprising the steps of:
1) polymerizing wood cellulose by replacing at least one of the hydroxyl groups on the wood cellulose with a molecule containing an atom from the group consisting of: Trivalent atoms, Tetravalent atoms or pentavalent atoms.

2) The method of claim 1 wherein the step of polymerization further comprises exposing the wood surface to a solution comprised of an organic solvent and a compound having the formula:
R-Xa-Xb3 wherein R is a carbon compound;
Xa is a trivalent, tetravalent or pentavalent atom; and
Xb is a reactive seven valence halogen, an alkoxy group, a phenoxy group, a benzyloxy group or an aryloxy group in which the aromatic ring is replaced with a polycyclic aromatic ring.

3) The method of claim 1 wherein the step of polymerizing comprises the steps of:
a) exposing the surface of the wood to a solution comprised of an organic solvent and a compound having the formula:
R3-Xa-Xb
wherein R is a carbon compound;
Xa is a trivalent, tetravalent or penta valent atom; and
Xb is a reactive seven valence halogen or an alkoxy group, a phenoxy group, a benzyloxy group or an aryloxy group.

4) The method of claim 1 wherein the step of polymerizing comprises a method comprising the steps of:
a) exposing the surface of the wood to a solution comprised of an organic solvent and a compound having the formula:
[R]₂ Si (X)₂; where R is an alkyl group ranging in carbon chain length of 1-20 units as a straight chain or as a branched chain, a phenyl group or a benzyl group and X is a halogen, an alkoxy, aryloxy or benzyloxy group.

5) The method of claim 1 wherein the step of polymerizing comprises a method comprising the steps of:
a) exposing the surface of the wood to a solution comprised of an organic solvent and a compound having the formula: [R]₃ Si—X, where where R is an alkyl group, a phenyl group or a benzyl group and X is a halogen, an alkoxy, aryloxy or benzyloxy group.

6) The method of claim 1 wherein the step of polymerizing comprises the steps of:
i) exposing the surface of the wood to a solution comprised of an organic solvent and a metal compound from the group consisting of:
Ti [R]₄,
where R is from the group consisting of a halogen, an alkoxy group, a phenoxy group or a benzyloxy group.

7) The method of claim 1 wherein the step of polymerizing comprises the steps of:
i) exposing the surface of the wood to a solution comprised of an organic solvent and a compound having the formula: R—Si—(X3) wherein X is a halogen an alkoxy group with the number of carbon ranging from 1 to 20 in a straight chain or a branched chain configuration, a phenoxy group, a benzyloxy group or an aryloxy group in which the aromatic ring is replaced with a polycyclic aromatic ring.

8) The method of claim 1 wherein the step of polymerizing comprises the steps of:
a) exposing the surface of the wood to a solution comprised of an organic solvents and a metal oxide having the formula oxide (X2O3) wherein X is a metals having a 3, 4 or 5 valence outer shell.

9) The method of claim 1 wherein the step of polymerizing comprises the steps of:
a) exposing the surface of the wood to a solution comprised of an organic solvent and;
a metal acid wherein the metal has a 3, 4 or 5 valence outer shell.

10) The method of claim 1 wherein the step of polymerizing comprises the steps of exposing the surface of the wood to a reactive borate having the general formula B(X)₃, where X is selected from a group consisting of methoxy, ethoxy, propoxy, butoxy or a higher alkoxy group with a straight or branched carbon chain consisting of 3-20 carbon atoms; a halogen, a phenoxy or benzyloxy group.

11) The method of claim 1 wherein the step of polymerizing comprises the steps of:
I) exposing the surface of the wood to a solution comprised of an organic solvents and a silicon compound from the group consisting of:
a) Chlorotrimethylsilane
b) phenyltrimethoxysilane
c) Triphenylsilylchloride
d) Propyltrichlorosilane
e) Propyltriethoxysilane
f) Hexamethyldisilanzane
g) Triethylorthosilicate
h) OCTEO-S [n-octyltriethoxysilane, TECH];
i) Octyltriethoxysilane;
j) Methyltrichlorosilane [MTS]
k) Chlorotrimethylsilane
l) Chlorotriphenylsilane.
m) Hexamethydisilazane:.
n) Octyltriethoxysilane [OTS];
o) Propyltriethoxysilane;
p) Dichlorodimethylsilane or
q) dichlorodiphenylsilane),

12) The method of claim 1 wherein the step of polymerizing comprises the steps of:
i) exposing the surface of the wood to a solution comprised of an organic solvent and a metal compound from the group consisting of:
a) Titanium tetrabutoxide [TBT],
b) trimethylborate [TMB],
c) Triethylborate,
d) Boron halides,
e) borontrichloride,
f) borontribromide,
g) borontrifluoride,
h) Triethylphosphate:
i) Trimethylphosphate.
j) Triethylphosphite:
k) trimethylborate [TMB]
l). Triethylphosphite
m) triethylphosphite;
n) Trimethylphosphite or
o) Triphenylphosphite

13) The method of claim 1 wherein the step of polymerizing comprises the steps of exposing the surface of the wood to reactive silicate containing carbon-silicon-halogen bonds in an organic solvent.

14) The method of claim 1 wherein the step of polymerizing comprises steps of exposing the wood to a solution comprised of trimethylborate TMB) and Methyltrichlorosilane (MTS).

15) The method of claim 1 wherein the step of polymerizing comprises the steps of exposing the interior layers of wood to borax, sodium silicate, metal carriers or metalloid carriers to render the wood hydrophobic, bug, rot or fire resistant.

16) The method of claim 1 wherein the step of polymerizing comprises the steps of exposing the surface of the wood to a reactive silicate having carbon-silicon-halogen bonds to render the wood hydrophobic, bug, rot and fire resistant.

17) The method of claim 1 wherein the step of polymerizing comprises the steps of:
A) Selecting an additive which may enhance a desired property from the group of properties comprising:
(a) Fire resistance,
(b) Insect resistance,
(c) Moisture resistance,
(d) Color;
(e) Adhesion,
(f) Insulation, and
(B) Changing the chemical structure of cellulose within the wood to change specific characteristics to the wood.
C) Adding the additive to the wood by one or more of the following methods;
(a) mixing particles of wood with the additives and forming a wood composite;
(b) dissolving the additive and flowing the additive into the wood or;
(c) pressing the additive with the wood in a gas or solid phase.

18) The claim of claim 17 further comprising the step of reforming the wood cellulose polymer to create a barrier to leaching of the additive from the wood.

19) The process of claim 1 wherein the step of polymerization further comprising the step of exposing the wood to a solvent containing trivalent, tetravalent or penta valent atoms and exposing the wood to ultra-sound sonication to facilitate penetration.

20) The method of claim 1 wherein the step of polymerization further comprises exposing the wood surface to a aqueous solvent containing trivalent, tetravalent or penta valent atoms in an appropriate concentration and exposure time sufficient to attain a treatment content of wood in the range of 0.1 to 10% based on the original weight of wood.

21) The method of claim 1 wherein the step of polymerization further comprises exposing the wood with a reactive silicate which is preferably a carbon silicon halogen combination which replaces some of the molecules or atoms within the cellulose structure with silicon, on a plurality.

22) The method of claim 19 wherein polymerization further comprises exposing the wood surface to a solvent under sonication in the ultra sound frequency range to attain a treatment content of wood in the range of 0.1 to 10% based on the weight of untreated wood samples.

23) The method of claim 1 wherein the step of polymerization further comprises replacing hydroxyl groups within the wood cellulose with boron and silicon in the range of 0.1-10% by weight.

24) The method of claim 1 wherein polymerization further comprises exposing the wood surface to a reactive borate having the general formula B(X)₃[boron reagent], where X is selected from a group consisting of methoxy, ethoxy, propoxy, butoxy or a higher alkoxy group with a straight or branched carbon chain consisting of 3-20 carbon atoms; a halogen; a phenoxy or benzyloxy.

25) The method of claim 1 wherein the step of polymerization further comprises exposing the wood interior to appropriate amounts of metal or matalloid catalysts, chemical enhancers, borax, and sodium silicate to render wood hydrophobic, bug, rot and fire resistant.

26) The method of claim 1 wherein the step of polymerizing comprises steps of placing the wood to be treated and chemicals in an enclosure under pressure.

27) The method of claim 1 wherein the step of polymerizing further comprises the step of infusing moisture into the wood before polymerizing.

28) The method of claim 1 wherein the step of polymerizing comprises the step of infusing molecular donors with trivalent, tetravalent or penta valent atoms within the wood prior to the addition of the solvent.

29) The method of claim 1 wherein the step of polymerizing comprises mixing a chemical with trivalent, tetravalent or penta valent atoms in an organic solvent from the group consisting of of acetone, THF (Tetrahydrofuran), Poly dimethylsiloxane, acetonitrile, dioxain, methyltrichlorosilane or another organic solvent with a boiling point under a 100 degrees Centrigrade.

30) The method of claim 1 wherein the step of polymerizing further comprises the steps of:
a) adding to the interior layer a reagent to enhance wood properties from the group of properties consisting of:
a) diatimatious earth,
b) sodium silicates,
c) boron or silicon salts,
e) boric acid,
f) trimethy (trialkyl) borate,
g) Boron Halides (BF3, BCl3, etc.),
h) Boric Anhydride (boron oxide),
i) phosphorous compounds,
j) copper compounds,
k) metal alkoxide,
l) meta-phosphoric acid;
m) a hydrophobic reagents,
n) phosphoric acid,
o) metaphoshoric acid
b) polymerizing the exterior layer to trap reagent with the wood.

31) A method for treating wood products having an interior layer and an exterior layer and a surface comprising the steps of:
a) adding to the interior layer a reagent to enhance wood properties from the group of properties consisting of:
a) diatimatious earth,
b) sodium silicates,
c) boron or silicon salts,
e) boric acid,
f) trimethy (trialkyl) borate,
g) Boron Halides (BF3, BCl3, etc.),
h) Boric Anhydride (boron oxide),
i) phosphorous compounds,
j) copper compounds,
k) metal alkoxide,
l) meta-phosphoric acid;
m) a hydrophobic reagents,
n) phosphoric acid,
o) metaphoshoric acid
b) polymerizing the exterior layer to trap reagent with the wood.

32) The method of claim 30 comprising the additional step of polymerization further comprises the step of exposing the surface of the wood to a reactive silicate having carbon-silicon-halogen bonds which have a carbon silicon-portion in a solvent to replace hydroxyl groups with the carbon silicon portion of the reactive silicon.

33) A cellulose molecule in a wooden structure wherein at least one hydroxyl group in the cellulose polymer is replaced with an atom or molecule from the group consisting of:
a) R-Xa or
b) R3-Xa
wherein R is a carbon compound, Xa is a trivalent, tetravalent or penta valent atom and Xb is a reactive seven valence halogen, an alkoxy group, propoxy, butoxy or an alkoxy group with the number of carbons ranging from 3 to 20 in a straight chain or a branched chain configuration a phenoxy group, a benzyloxy group or an aryloxy group in which the aromatic ring is replaced with a polycyclic aromatic ring.
